(19) United States
(12) Patent Application Publication
(10) Pub. No.: US 2025/0275543 A1
(43) Pub. Date: Sep. 4, 2025

(54) APPARATUS AND METHOD FOR ANAESTHETISING POULTRY TO BE SLAUGHTERED

(71) Applicant: BAADER Food Systems Denmark A/S, Trige (DK)

(72) Inventors: Craig Farley, Tilst (DK); Piotr Ptaszek, Trige (DK)

(21) Appl. No.: 18/859,704

(22) PCT Filed: Apr. 26, 2022
(86) PCT No.: PCT/EP2022/061063

§ 371 Date: Oct. 24, 2024

(51) Int. Cl. A22B 3/08; A22B 3/00

(52) U.S. Cl. CPC A22B 3/086; A22B 3/005

(57) ABSTRACT

An apparatus for stunning, in a stunning chamber, poultry animals for slaughter supplied in transport containers, includes a stunning chamber, a transport device for introducing the containers into the chamber, transporting therethrough and discharging therefrom. The stunning chamber has a vertically oriented stunning shaft. The transport device has a lifting device to lower each container into the chamber, top to bottom, on a first transport path. Each container is transported in the stunning shaft bottom region transversely from the first to a second transport path and is lifted, bottom to top, on the second path. A device in the shaft bottom region introduces stunning gas into the shaft to form inside the stunning chamber a stunning medium of ambient air and stunning gas. A ventilation system inside the stunning shaft circulates parts of the stunning medium in an upper region of the chamber. A method is also provided.

### CROSS-REFERENCE TO RELATED APPLICATION

The present application is the National Phase entry of International Patent Application No. PCT/EP2022/061063, filed Apr. 26, 2022, the entire contents are hereby incorporated by reference into this application.

### FIELD OF THE INVENTION

The invention relates to an apparatus, configured and adapted for stunning, in a stunning chamber, poultry animals for slaughter which are supplied in transport containers, comprising a stunning chamber, a transport device for introducing the transport containers into the stunning chamber, transporting the transport containers through the stunning chamber and discharging the transport containers from the stunning chamber, wherein the stunning chamber has at least one vertically oriented stunning shaft and the transport device comprises at least one lifting device, such that each transport container can be lowered into the stunning chamber from top to bottom on a first transport path, can be transported in the region of a bottom of the stunning shaft transversely from the first transport path to a second transport path and can be lifted from bottom to top on the second transport path, and also a device, arranged in the region of the bottom of the stunning shaft, for introducing stunning gas into the stunning shaft so as to form inside the stunning chamber a stunning medium formed of ambient air and stunning gas.

The invention relates further to a method for stunning, in a stunning chamber, poultry animals for slaughter which are supplied to the stunning chamber in transport containers, comprising the steps: introducing the transport containers with the live and alert poultry animals for slaughter into the stunning chamber, lowering the transport containers from top to bottom in a vertically oriented stunning shaft of the stunning chamber along a first transport path, transporting the transport containers in the region of a bottom of the stunning shaft transversely from the first transport path to a second transport path, lifting the transport containers with the stunned poultry animals for slaughter from bottom to top along the second transport path, and discharging the transport containers, wherein stunning gas is introduced into the stunning shaft in the region of the bottom of the stunning shaft so as to form inside the stunning chamber a stunning medium formed of ambient air and stunning gas, such that the transport containers with the poultry animals for slaughter located therein pass along the first transport path firstly through a first, upper chamber portion having a first gas concentration of the stunning gas and then through a second, lower chamber portion having a second gas concentration of the stunning gas, wherein the second gas concentration is higher than the first gas concentration.

### BACKGROUND OF THE INVENTION

Such apparatuses and methods are used in the poultry-processing industry to stun poultry animals for slaughter, that is to say in particular live and alert chickens, which are delivered in transport containers, before they are actually processed, that is to say in particular slaughtered and eviscerated. For transport, multiple poultry animals for slaughter are accommodated in a transport container. The poultry animals for slaughter are supplied to the stunning apparatus in these transport containers, namely in individual transport containers or in stacks of transport containers. The transport containers or the stacks formed of two or more transport containers can be supplied on one lane, on two lanes or on multiple lanes. Stunning of the poultry animals for slaughter must be carried out—in accordance with animal welfare—very carefully in multiple steps. According to existing animal welfare guidelines, the poultry animals for slaughter must be brought into a pre-stunned state or state of sleep prior to actual final stunning, which is carried out with a gas concentration of the stunning gas (e.g. carbon dioxide (CO₂)) in the stunning medium of 40% or more. To that end, prior to actual and final stunning, the poultry animals for slaughter are to be exposed to a stunning medium that has a gas concentration of the stunning gas of about 20%. In other words, the poultry animals for slaughter pass through at least two stunning stages having different gas concentrations of the stunning gas in the stunning medium.

The stunning stages are formed in the stunning apparatus by different levels or layers of stunning medium inside the stunning chamber. The stunning gas is introduced into the stunning chamber in the region of the bottom of the stunning shaft, so that the stunning gas mixes with ambient air to form the stunning medium. In the stunning chamber, into which the stunning gas, for example CO₂, is introduced in the region of the bottom, different gas concentrations prevail owing to the higher density of CO₂ and other suitable and permitted stunning gases relative to the ambient air. The gas concentration of the stunning gas increases from top to bottom. By means of the transport device comprising the at least one lifting device, the transport containers are moved downwards along the first transport path, so that the poultry animals for slaughter are first exposed in an upper chamber portion to the stunning medium having the lower gas concentration of the stunning gas. As a result, the poultry animals for slaughter fall into a sleep-like state. The pre-stunned/sleeping poultry animals for slaughter are then transported by the transport device further downwards in the direction towards the bottom into the lower chamber portion having the higher gas concentration of the stunning gas, so that they reach the final state of stunning. The transport containers can here be transported right to the bottom or—in order to achieve a shorter distance/a shorter residence time in the stunning chamber—in the direction towards the bottom. The poultry animals for slaughter, which have now been subjected to final stunning, are then transported by means of the transport device—in the region of the bottom or also above the bottom—transversely/laterally in order then to be transported upwards by means of the transport device along the second transport path.

In the known apparatuses for stunning poultry animals there is a common and barrier-free stunning chamber into which the stunning gas is introduced or pumped from the bottom. On the one hand, this has the result that an inconsistent gradient of the gas concentration in the stunning chamber is established. It can happen that the region having the higher gas concentration of the stunning gas of 40% or more extends from the lower chamber portion into the upper chamber portion, so that the still alert poultry animals for slaughter are exposed directly to the stunning medium having the high gas concentration for final stunning. On the other hand, it can lead to the stunning gas sinking in an uncontrolled manner as a result of its higher density, so that there is formed in the upper chamber portion of the stunning chamber a stunning medium in which the gas concentration of the stunning gas is below 20%, so that the poultry animals for slaughter are in an alert state when they reach the lower chamber portion of the stunning chamber having a gas concentration of the stunning gas of 40% or more. In all cases, pumping of the stunning gas into the barrier-free stunning chamber from the bottom results in a composition of the stunning medium in the chamber portions of the stunning chamber that is uncontrolled and changes uncontrollably, leading to stunning of the poultry animals for slaughter that is unreliable and detrimental to animal welfare. Furthermore, in particular in the case of prolonged downtimes of the apparatus, an undesirable/uncontrolled adjustment of the composition of the stunning medium can occur as a result of the stunning gas sinking inside the stunning chamber.

### SUMMARY OF THE INVENTION

Accordingly, the object of the present invention is to provide a simple and reliable apparatus for the controlled and gentle stunning of the poultry animals for slaughter. It is a further object of the invention to propose a corresponding method.

This object is achieved by an apparatus having the features mentioned at the beginning in that there is arranged inside the stunning shaft of the stunning chamber a ventilation system which is configured and adapted to circulate at least parts of the stunning medium at least in an upper region of the stunning chamber. The ventilation system is arranged inside the stunning shaft, which can be, for example, a pit set into the ground, and is configured and adapted such that an air stream formed of the stunning medium circulates in the upper region, that is to say in the upper chamber portion. As a result of the circulation, that is to say the suctioning and return of the stunning medium, an (invisible) air/flow curtain forms and divides the at least two chamber portions having different gas concentrations, namely into the upper chamber portion having the lower gas concentration (about 20%) of the stunning gas and the lower chamber portion having a higher gas concentration (about 40%) of the stunning gas. The circulation of the stunning medium at least in the upper chamber portion forms a kind of barrier between the chamber portions, which at least partly prevents free mixing of the stunning medium between the chamber portions. In particular, the circulation also reduces the risk that the stunning gas with the greater density compared to the ambient air will settle from the upper chamber portion into the lower chamber portion. By creating constant stunning conditions in the respective chamber portions having the respective gas concentrations of the stunning gas in the stunning medium, the poultry animals for slaughter are calmer and subjected to greater animal welfare during stunning, which is also reflected in a higher quality of the flesh harvested from the slaughtered poultry animals.

A particularly preferred embodiment of the apparatus is characterised in that the ventilation system comprises means for changing the gas concentration of the stunning gas in the circulated stunning medium. The means can be configured and adapted to increase the gas concentration or to reduce the gas concentration at least in the upper chamber portion. Targeted and local adjustment of the gas concentration of the stunning gas within the stunning medium is thus ensured at least in the upper chamber portion. As a result, the distribution of the necessary and desired gas concentrations of the stunning gas in the stunning chamber can be retained more easily and more precisely and in particular can also be monitored and adjusted, which results in better and more gentle calming of the poultry animals for slaughter, an improvement in animal welfare and thus an improved quality of the flesh to be harvested from the slaughtered poultry. Before the poultry animals for slaughter are finally stunned in the lower chamber portion, they are first brought safely, reliably and gently into a sleep-like state in the upper chamber portion, which meets the guidelines for stunning poultry animals for slaughter.

Advantageously, the ventilation system comprises at least a first pipe circuit, which is arranged at least in part inside the stunning shaft, wherein the first pipe circuit is configured and adapted to suction stunning medium out of a first, upper chamber portion of the stunning chamber, which is located at the upper end of the stunning chamber, and to return the suctioned stunning medium into the first, upper chamber portion. The pipe circuit is configured and arranged such that the suctioning and return of the stunning medium preferably takes place at the upper end of the first, upper chamber portion. The pipe circuit is preferably arranged wholly inside the stunning shaft, wherein parts of the pipe circuit can also be guided along on the outside of the stunning shaft. With the or each pipe circuit, circulation to form an air curtain can be achieved in a simple and compact manner. The pipe circuit further makes it possible, in a simple manner, to position, or to define the position of, the transition between the two chamber portions for “dividing” the stunning chamber into multiple portions/stages, through which the poultry animals for slaughter can then pass by means of the transport device.

A particularly preferred further development of the apparatus is characterised in that the ventilation system comprises at least a second pipe circuit, which is arranged at least in part inside the stunning shaft, wherein the second pipe circuit is configured and adapted to suction stunning medium out of a second, lower chamber portion of the stunning chamber, which is located below the first, upper chamber portion of the stunning chamber, and to return the suctioned stunning medium into the second, lower chamber portion. The second pipe circuit is configured and arranged such that the suctioning and return of the stunning medium preferably takes place at the upper end of the second, lower chamber portion. The second pipe circuit is preferably arranged wholly inside the stunning shaft, wherein parts of the pipe circuit can also be guided along on the outside of the stunning shaft. Preferably, the second pipe circuit, for a compact and space-saving construction, extends parallel to the first pipe circuit or follows the first pipe circuit. With the provision of two separate pipe circuits, an even more distinct “separation” of the two chamber portions from one another can be achieved, so that the desired and necessary gas concentrations of the stunning gas in the respective chamber portions can be maintained reliably and kept constant.

A preferred further development of the apparatus is distinguished in that each pipe circuit comprises at least pipes for conducting the stunning medium, at a first free end of the pipes means for suctioning the stunning medium out of the respective chamber portion and at the opposite, second free end of the pipes means for returning the suctioned stunning medium into the respective chamber portion, means for transporting the stunning medium through the pipes, and also measuring means for measuring the gas concentration of the stunning medium suctioned out of the respective chamber portion. The means for suctioning and the means for returning the stunning medium are located in the region of the respective chamber portion. The pipes can lie inside the respective chamber portion or also at least in part outside the respective chamber portion. With this embodiment, circulation of the stunning medium is ensured in a simple and compact manner. Each pipe circuit is configured independently of the other pipe circuit.

An advantageous embodiment of the apparatus is characterised in that there are associated with each pipe circuit means for supplying stunning gas and/or ambient air into the pipes. This embodiment of the means for changing the gas concentration of the stunning gas allows the gas concentration to be adjusted and changed online, as it were, namely in a very precise and simple manner, in that, for example, pure stunning gas or pure ambient air or a mixture thereof can be introduced directly and without an intermediate means into the circulating stunning medium of the respective pipe circuit.

In particular, the respective pipe circuits can thus be adjusted separately and individually in respect of the respective gas concentration.

Advantageously, each pipe consists of at least three portions, namely at least one portion oriented vertically downwards, at least one portion oriented vertically upwards, and at least one horizontally oriented portion connecting the two vertically oriented portions. The pipes can also be formed integrally or in one piece. A configuration of the pipes in more than three pieces is also achievable. The multi-piece form, in particular when the portions are detachably connected to one another, ensures individual adjustment to the external conditions, such as, for example, the inner shape/contour of the stunning shaft, the configuration and construction of the transport device, in order, for example, to permit a collision-free arrangement of the ventilation system inside the stunning shaft. The vertical portions can extend from the upper end of the stunning shaft to the bottom of the stunning shaft, or only over parts thereof. The distance of the vertical portions of the pipes from one another corresponds at least to the width of a transport container, in the case where the stunning shaft is filled from multiple lines, at least to the width of the number of transport containers located side by side. Particularly preferably, the pipes follow the principle of the shortest path in order to connect together the means for suctioning and the means for returning.

Preferably, there is associated with each pipe at least one drive for suctioning the stunning medium into the pipe and returning the stunning medium from the pipe. Ultimately, a pump, for example, can be used as the drive for each pipe circuit. Preferably, however, two pumps, motors, drives or other devices configured and adapted to generate a flow are associated with each pipe circuit. Particularly preferably, a separate drive is associated with each vertically oriented portion of the pipes, in order to be able to control the suctioning on the one hand and the return on the other hand in a targeted and individual manner. The number and position of the drives can vary. Preferably, the drives are placed in the vicinity of the means for suctioning or returning.

A preferred further development of the apparatus is characterised in that the means for suctioning the stunning medium comprises at least one suction nozzle. The means can also comprise two or more suction nozzles, the form, shape and number of which can vary and in particular is adapted to the dimensions of the respective chamber portion.

Particularly advantageously, the or each suction nozzle is oriented transversely and/or in parallel with respect to the vertically oriented portions of the pipes. In particular when the or each suction nozzle is in elongate form or in the form of a suction nozzle bar, a horizontal orientation is preferred, such that the stunning medium can be suctioned over the entire width of the chamber portion. For reasons of space or in order to avoid collisions of the transport containers with the or each suction nozzle or for other reasons, this can then also be oriented vertically. In the case where more than one suction nozzle is provided, some suction nozzles can be oriented horizontally and other suction nozzles can be oriented vertically.

Advantageously, the measuring means for measuring the gas concentration of the stunning gas in the stunning medium suctioned out of the respective chamber portion is associated with the means for suctioning the stunning medium. The actual gas concentration can thus be determined directly during suctioning, with sufficient time to determine the deviation from the target value and optionally control the means for changing the gas concentration.

Expediently, at least one sensor for detecting the gas concentration of the stunning gas in the suctioned stunning medium is arranged inside each suction nozzle. More than one sensor may also be provided. Other detection means, in particular for determining the gas concentration, but also for determining other parameters, such as, for example, the flow velocity of the stunning medium, can be arranged in the region of the suction nozzle and/or inside the pipes as far as the means for returning. Particularly preferably, all the detected values or information otherwise determined are recorded and preferably forwarded to a control device for processing.

Preferably, the means for returning the stunning medium comprises at least one return nozzle. The means may also comprise two or more return nozzles, the form, shape and number of which can vary and in particular is adapted to the dimensions of the respective chamber portion.

Advantageously, the or each return nozzle is oriented transversely and/or in parallel with respect to the vertically oriented portions of the pipes. In particular when the or each return nozzle is in elongate form or in the form of a suction nozzle bar, a horizontal orientation is preferred, such that the stunning medium can be returned over the entire width of the chamber portion. For reasons of space or in order to avoid collisions of the transport containers with the or each return nozzle or for other reasons, this can then also be oriented vertically. In the case where more than one return nozzle is provided, some return nozzles can be oriented horizontally and other return nozzles can be oriented vertically.

A particularly preferred embodiment of the apparatus is characterised in that the means for changing the gas concentration of the stunning gas is associated with the means for returning the stunning medium. A targeted and precise adjustment of the gas concentration directly before the stunning medium enters the stunning chamber again is thus ensured.

In order to ensure a continuous or stepwise adjustment of the gas concentration in a simple and reliable manner, means for the external supply of ambient air and/or stunning gas are associated with each return nozzle. In this context, “external” means that the supplied/added components, ambient air and/or stunning gas, are supplied to the circulation from the outside in order to adjust/change the composition of the stunning medium. The means for supplying ambient air and/or stunning gas preferably comprise supply pipes, which are arranged in the region of each return nozzle and are connected thereto. The supply pipes optionally connect a reservoir of stunning gas or ambient air, which ensures either a separate supply of the components or a joint, mixed supply of the components.

A particularly preferred further development of the apparatus is characterised in that the ventilation system is connected to a control device for adjusting the gas concentration of the stunning gas in the stunning medium. Optionally, some or all of the components which can contribute towards changing the circulation and/or the gas concentration, that is to say in particular means for suctioning the stunning medium having the measuring means for measuring the gas concentration, means for returning the stunning medium having the means for the external supply of ambient air and/or stunning gas and also drives for transporting the stunning medium inside the pipes, are connected to the control device. Furthermore, the transport device can also be connected to the control device.

The object is also achieved by a method having the steps mentioned at the beginning, which method is characterised in that the stunning medium is circulated at least in an upper region of the stunning chamber, that is to say at least in the first, upper chamber portion, in that at least part of the stunning medium is suctioned out of the first, upper chamber portion and returned into the first, upper chamber portion. A permanent flow movement of parts of the stunning medium is thus achieved, namely the part located in the first, upper chamber portion, as a result of which separation from the stunning medium in the second, lower chamber portion is ultimately achieved. In other words, the circulation of the stunning medium in one chamber portion forms a kind of barrier between the chamber portions, with the result that the respective gas concentrations in the respective chamber portions can be kept substantially constant.

Preferably, the stunning medium is additionally and separately circulated in a lower region of the stunning chamber, that is to say in the second, lower chamber portion, in that at least part of the stunning medium is suctioned out of the second, lower chamber portion and returned into the second, lower chamber portion. The effect achieved by the circulation in the first, upper chamber portion is enhanced further by the circulation in the lower, second portion. Moreover, the stunning chamber can also be divided into more than two chamber portions, wherein circulation of the stunning medium can then be carried out in each of the multiple chamber portions.

Preferably, the gas concentration of the stunning gas in the circulated stunning medium is adjusted for each chamber portion. The adjustment can be carried out continuously or stepwise and serves to keep the gas concentration in each chamber portion at the desired and necessary level. Expressed differently, an individual adjustment of the gas concentration is carried out, preferably continuously, in separate circuits, so that the poultry animals for slaughter are first brought into a state of sleep in the first, upper chamber portion having a gas concentration of the stunning gas of about 20% before they are finally stunned with a gas concentration of the stunning gas of about 40%.

To that end, the gas concentration of the stunning gas in the circulated stunning medium is detected after suctioning out of the respective chamber portion. If the gas concentration in the circulated stunning medium deviates from a target value, the gas concentration is adjusted in that stunning gas and/or ambient air is supplied to the circulated stunning medium when it is returned into the respective chamber portion.

Advantageously, the circulation of the stunning medium and/or the adjustment of the gas concentration of the stunning gas in the circulated stunning medium is controlled separately for each chamber portion.

The method is particularly preferably carried out using an apparatus according to one or more of claims 1 to 19.

Further advantages arising from the individual method steps have already been described in connection with the apparatus and therefore, in order to avoid repetition, reference is made to the corresponding passages.

### BRIEF DESCRIPTION OF THE DRAWINGS

Further expedient and/or advantageous features and further developments relating to the apparatus and to the corresponding method will become apparent from the dependent claims and the description. Particularly preferred embodiments will be explained in greater detail with reference to the accompanying drawing. The drawing shows:

FIG. 1 is a schematic representation of the apparatus according to the invention with two-lane supply of transport containers and one-lane discharge thereof, in a front view;

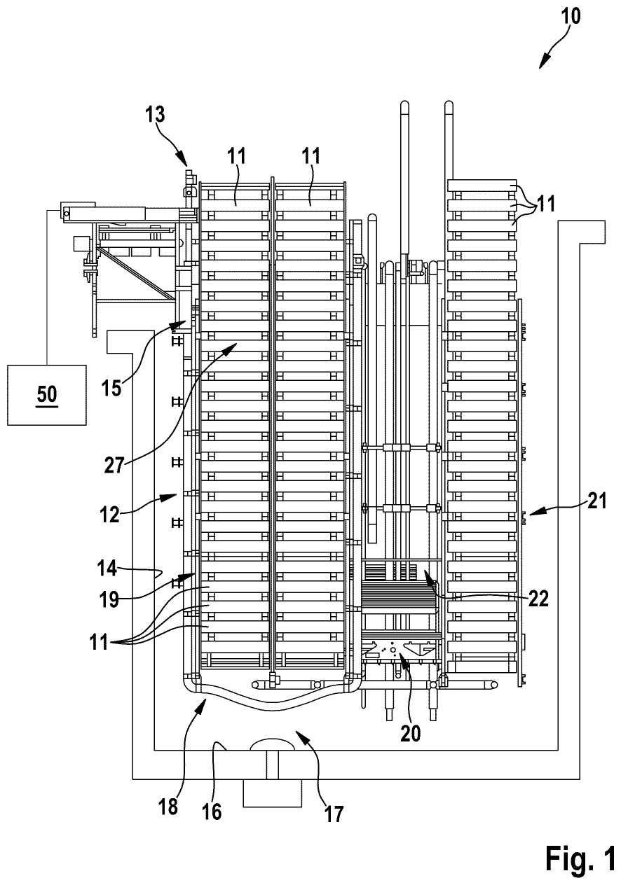

FIG. 2 is the apparatus according to FIG. 1 in a perspective view obliquely from behind; and

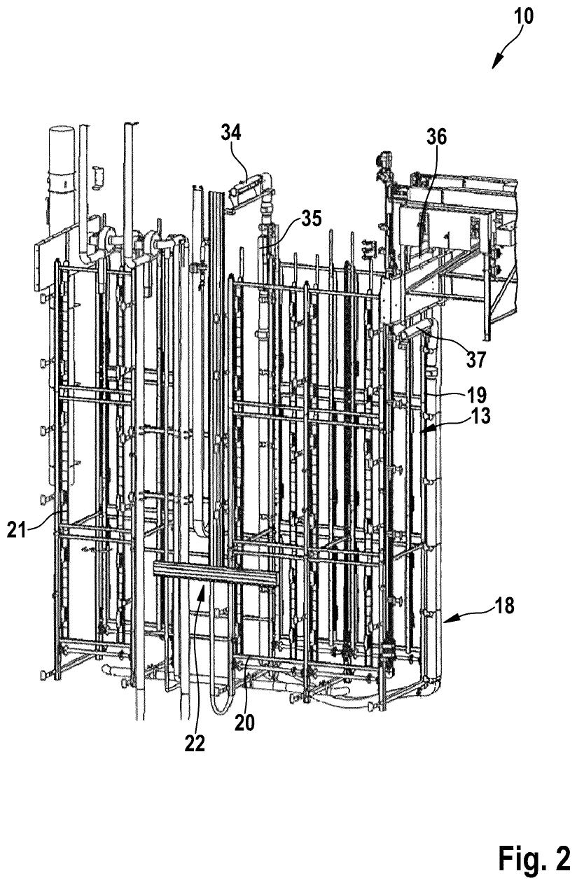

FIG. 3 is a schematic representation of a ventilation system in a perspective view.

### DETAILED DESCRIPTION OF THE INVENTION

The apparatus according to the invention which is shown serves to stun poultry animals for slaughter. The invention will be described with reference to an apparatus in which the transport containers are supplied on two lines to the region of a stunning chamber set into the ground. The invention can of course also be used in the case of apparatuses in which the transport containers are supplied on one line or on multiple lines to a vertically oriented stunning chamber which is configured and positioned above ground level. Ultimately, the ventilation system can be used in any apparatus for stunning different types of animal in which the stunning chamber is divided or is to be divided into two or more chamber portions.

The apparatus 10 shown in the drawing is configured and adapted for stunning, in a stunning chamber 12, poultry animals for slaughter which are supplied in transport containers 11, and comprises a stunning chamber 12, a transport device 13 for introducing the transport containers 11 into the stunning chamber 12, transporting the transport containers 11 through the stunning chamber 12 and discharging the transport containers 11 from the stunning chamber 12, wherein the stunning chamber 12 has at least one vertically oriented stunning shaft 14 and the transport device 13 comprises at least one lifting device 15, such that each transport container 11 can be lowered into the stunning chamber 12 from top to bottom on a first transport path, can be transported in the region of a bottom 16 of the stunning shaft 14 transversely from the first transport path to a second transport path and can be lifted from bottom to top on the second transport path, and also a device 17, arranged in the region of the bottom 16 of the stunning shaft 14, for introducing stunning gas into the stunning shaft 14 so as to form inside the stunning chamber 12 a stunning medium formed of ambient air and stunning gas.

This apparatus 10 is distinguished according to the invention in that there is arranged inside the stunning shaft 14 of the stunning chamber 12 a ventilation system 18 which is configured and adapted to circulate at least parts of the stunning medium at least in an upper region of the stunning chamber 12.

The features and further developments described hereinbelow represent preferred embodiments when considered on their own or in combination with one another. It is expressly pointed out that features which are combined in the claims and/or the description and/or the drawing or which are described in a common embodiment can also further develop the above-described apparatus 10 functionally independently.

The transport device 13 having the at least one lifting device 15 comprises a first lift 19 for transporting the transport containers 11 from top to bottom along the first transport path, a cross conveyor 20 for transporting the transport containers 11 from the first transport path to the second transport path, and a second lift 21 for transporting the transport containers 11 from bottom to top along the second transport path. In the embodiment shown, the first lift 19 is configured and adapted to transport two transport containers 11 side by side (or stacks formed of multiple transport containers and located side by side). The second lift 21 is configured and adapted to transport one transport container 11 (or one stack formed of multiple transport containers). A distance having at least the width of a transport container 11 is configured between the first lift 19 and the second lift 21, such that, in the region of the cross conveyor 20, two transport containers 11 located side by side are transported transversely from the first transport path to the second transport path, wherein one of the transport containers 11 is supplied directly to the second lift 21 while a second transport container 11 is stored temporarily in a temporary store 22. The lifts 19, 21 have separate drives (not shown explicitly) by means of which the lifts 19, 21 can be driven synchronously or separately. Preferably, the transport speed of the second lift 21 is higher than that of the first lift 19.

The ventilation system 18 comprises means 23.1, 23.2 for changing the gas concentration of the stunning gas in the circulated stunning medium. The means 23.1, 23.2 can have feed pipes and/or discharge pipes, nozzles, reservoirs for storing stunning gas and/or ambient air, and/or other additional components, drives or pumps for conveying the external constituents which are to be supplied to the stunning medium, and also further components which are configured and adapted to change the gas concentration. A concrete embodiment will be described hereinbelow.

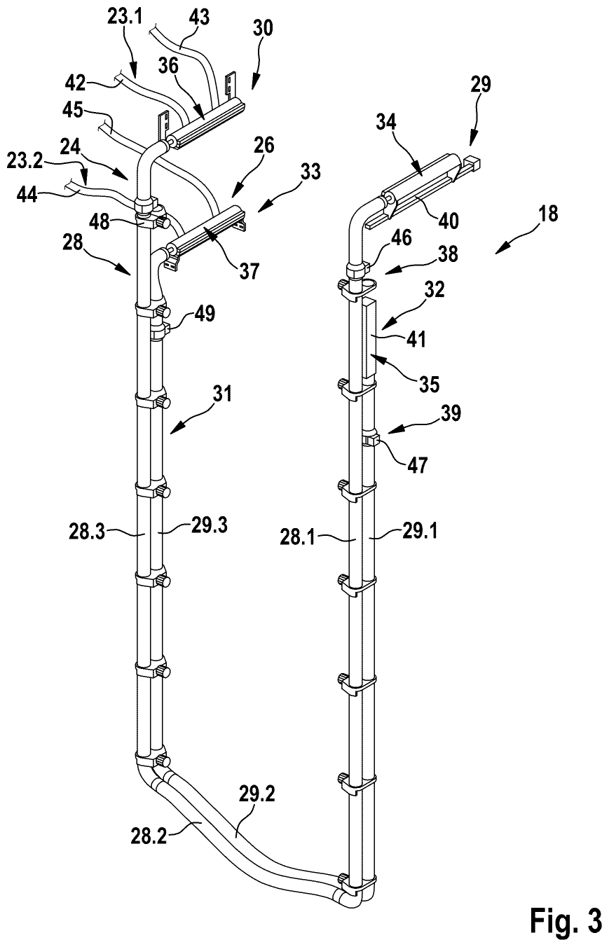

The ventilation system 18 (see in particular FIG. 3) comprises at least a first pipe circuit 24, which is arranged at least in part inside the stunning shaft 14, wherein the first pipe circuit 24 is configured and adapted to suction stunning medium out of a first, upper chamber portion 25 of the stunning chamber 12, which is located at the upper end of the stunning chamber 12, and to return the suctioned stunning medium into the first, upper chamber portion 25. In addition, the ventilation system 18 comprises at least a second pipe circuit 26, which is arranged at least in part inside the stunning shaft 14, wherein the second pipe circuit 26 is configured and adapted to suction stunning medium out of a second, lower chamber portion 27 of the stunning chamber 12, which is located below the first, upper chamber portion 25 of the stunning chamber 12, and to return the suctioned stunning medium into the second, lower chamber portion 27. In further embodiments, three or more pipe circuits 24, 26 can also be provided.

Each pipe circuit 24, 26 comprises at least pipes 28, 31 for conducting the stunning medium, at a first free end 29, 32 of the pipes 28, 31 means 34, 35 for suctioning the stunning medium out of the respective chamber portion 25, 27, and at the opposite, second free end 30, 33 of the pipes 28, 31 means 36, 37 for returning the suctioned stunning medium into the respective chamber portion 25, 27, means 38, 39 for transporting the stunning medium through the pipes 28, 31, and also measuring means 40, 41 for measuring the gas concentration of the stunning medium suctioned out of the respective chamber portion 25, 27. Each pipe 28, 31 with the means 34, 35 for suctioning and means 36, 37 for returning arranged at the free ends 29, 30; 32, 33 can individually be configured and arranged inside the stunning shaft 14. In the exemplary embodiment shown, the means 34 for suctioning and the means 36 for returning of the first pipe circuit 24 project into the first, upper chamber portion 25, or face that chamber portion, while the means 35 for suctioning and the means 37 for returning of the second pipe circuit 26 project into the second, lower chamber portion 27, or are turned towards that chamber portion. The distance of the respective means 34, 36 of the first pipe circuit 24 on the one hand from the means 35, 37 of the second pipe circuit 26 on the other hand can vary. In the apparatus 10 shown, all the means 34, 36; 35, 37 of the two pipe circuits 24, 26 are located in the upper third of the stunning chamber 12. The means 35, 37 of the second pipe circuit 26 for the lower chamber portion 27 can also be placed, for example, lower down in the chamber portion 27. Other arrangements and placings or positionings of the means 34, 36; 35, 37 are of course possible.

Furthermore, means 42, 43; 44, 45 for supplying stunning gas and/or ambient air into the pipes 28, 31 are associated with each pipe circuit 24, 26. The corresponding means 42 to 45 are shown only schematically and can comprise, for example, injection nozzles, valves or the like for the metered introduction of stunning gas and/or ambient air. The means 23.1, 23.2 for changing the gas concentration of the stunning gas is associated with the means 36, 37 for returning the stunning medium. The means 23.1, 23.2 for changing the gas concentration comprises, in addition to the means 42 to 45—in the case shown supply pipes-for supplying the stunning gas and/or the ambient air, also reservoirs (not shown explicitly) for storing the media to be supplied, pumps or other drives for actively introducing/transporting the media, and also valves by means of which the media can be introduced in a targeted manner into the pipe circuits 24, 26. At least one means 42 to 45 for the external supply of ambient air and/or stunning gas is associated with each return nozzle. To that end, the supply pipes open/end in the return nozzles. The means 23.1, 23.2 can of course also be mounted at different positions. Also conceivable is a single pipe which can be connected via switch valves to different reservoirs, such that either only stunning gas or only ambient air or a mixture of stunning gas and ambient air can be supplied to the pipe circuits 24, 26 by the single pipe.

In the embodiment shown, each of the pipes 28, 31 is formed of at least three portions 28.1, 28.2, 28.3; 29.1, 29.2, 29.3, namely at least one portion 28.1, 29.1 oriented vertically downwards, at least one portion 28.3, 29.3 oriented vertically upwards, and at least one horizontally oriented portion 28.2, 29.2 connecting the two vertically oriented portions 28.1, 28.3; 29.1, 29.3. The three portions 28.1, 28.2, 28.3; 29.1, 29.2, 29.3 in each case form a U-shape. The vertical portions 28.1, 28.3; 29.1, 29.3 here extend from the upper edge of the stunning shaft 14 into the region of the bottom 16 of the stunning shaft 14. For connecting the respective means 34, 36; 35, 37 by the shortest path, the vertical portions 28.1, 28.3; 29.1, 29.3 can also be made shorter and have different profiles.

Associated with each pipe 28, 31 is at least one drive for suctioning the stunning medium into the pipe 28, 31 and returning the stunning medium from the pipe 28, 31. Preferably, two motors 46, 47; 48, 49, pumps or the like are associated with each pipe 28, 31. One motor 46, 48 is preferably arranged directly behind the means 34, 35 for suctioning, that is to say in the transition region between the means 34, 35 and the vertical portion 28.1, 29.1. A further motor 47, 49 is preferably arranged directly in front of the means 36, 37 for returning, that is to say in the transition region between the means 36, 37 and the vertical portion 28.3, 29.3. The number and position of the motors 46 to 49 can vary.

The means 34, 35 for suctioning the stunning medium comprises at least one suction nozzle. Preferably, each suction nozzle is of elongate form to form a suction bar. The suction opening of each suction nozzle/suction bar is directed into the respective chamber portion 25, 27, in order to allow stunning medium to be sucked in over the entire width of the chamber portion 25, 27. In principle, the suction nozzles are oriented horizontally, that is to say transverse to the vertical portions 28.1, 29.1. This also applies to the suction nozzle of the first pipe circuit 24. In the exemplary embodiment shown, the suction nozzle of the second pipe circuit 26 is oriented vertically, that is to say parallel to the vertical portions 28.1, 29.1. Ultimately, the orientation can vary inter alia in dependence on the structural conditions and the transport paths of the transport containers 11.

The measuring means 40, 41 for measuring the gas concentration of the stunning gas in the stunning medium suctioned out of the respective chamber portion 25, 27 is associated with the means 34, 35 for suctioning the stunning medium. Preferably, at least one sensor for detecting the gas concentration of the stunning gas in the suctioned stunning medium is arranged inside each suction nozzle. The sensor or any other measuring means 40, 41 suitable for determining the gas concentration can also be arranged at another position of the pipes 28, 31.

The means 36, 37 for returning the stunning medium comprises at least one return nozzle. Preferably, each return nozzle is of elongate form to form a return bar. The return opening of each return nozzle/return bar is directed into the respective chamber portion 25, 27, in order to allow stunning medium to be returned over the entire width of the chamber portion 25, 27. In principle, the return nozzles are oriented horizontally, that is to say transverse to the vertical portions 28.3, 29.3. The return nozzles of the two pipe circuits 24, 26 are oriented accordingly. Ultimately, the orientation can vary inter alia in dependence on the structural conditions and the transport paths of the transport containers 11. In particular, the return nozzles can also be oriented vertically, that is to say parallel to the vertical portions 28.3, 29.3.

The ventilation system 18 is connected to a control device 50 for adjusting the gas concentration of the stunning gas in the stunning medium. The control device 50 can comprise, in addition to a processor by means of which the detected data and information are processed, also storage media, for example in order to store data sets. However, in particular the means 23.1, 23.2 for adjusting the gas concentration in the stunning medium can be controlled by means of the control device 50, in order to keep the composition of the stunning medium constant in the desired and necessary concentration.

The method according to the invention will be described in greater detail hereinbelow with reference to the drawing.

The method serves for stunning, in a stunning chamber 12, poultry animals for slaughter which are supplied in transport containers 11 to the stunning chamber 12, and is correspondingly configured. The poultry animals for slaughter are conventionally placed into the transport containers 11 in the area of a breeding farm, wherein there are preferably multiple poultry animals for slaughter in one transport container 11. The or each transport container 11 with the live and alert poultry animals for slaughter is introduced for stunning into the stunning chamber 12. In the stunning chamber 12, the transport containers 11 are transported along a given path. To that end, each transport container 11 is first lowered from top to bottom in a vertically oriented stunning shaft 14 of the stunning chamber 12 along a first transport path. Then, in the region of a bottom 16 (or in the case of shorter transport paths also above the bottom) of the stunning shaft 14, the transport container 11 is transported transversely from the first transport path to a second transport path. The transport container 11 with the stunned poultry animals for slaughter is then lifted from bottom to top along the second transport path. Finally, the transport container 11 is discharged from the stunning chamber 12. In the region of the bottom 16 of the stunning shaft 14, stunning gas is introduced into the stunning shaft 14 to form inside the stunning chamber 12 a stunning medium formed of ambient air and stunning gas. Because the stunning gas is introduced in the region of the bottom 16 and the density of the stunning gas is higher than that of the ambient air, layers having different gas concentrations of the stunning gas form inside the stunning chamber 12, wherein the gas concentration of the stunning gas increases from top to bottom. As a result, the transport containers 11 with the poultry animals for slaughter located therein pass along the first transport path firstly through a first upper chamber portion 25 having a first gas concentration of the stunning gas and then through a second, lower chamber portion 27 having a second gas concentration of the stunning gas, wherein the second gas concentration is higher than the first gas concentration.

This method is distinguished according to the invention in that the stunning medium is circulated at least in an upper region of the stunning chamber 12, that is to say at least in the first, upper chamber portion 25, in that at least part of the stunning medium is suctioned out of the first, upper chamber portion 25 and returned into the first, upper chamber portion 25.

Preferably, the stunning medium is additionally and separately circulated in a lower region of the stunning chamber 12, that is to say in the second, lower chamber portion 27, in that at least part of the stunning medium is suctioned out of the second, lower chamber portion 27 and returned into the second, lower chamber portion 27. Merely the circulation of at least parts of the stunning medium in each chamber portion 25, 27 has the result that the different layers of the stunning medium having different gas concentrations of the stunning gas remain at least partially “separated”, that is to say a free exchange in particular of the stunning gas between the two chamber portions 25, 27 is prevented or at least made more difficult.

In addition, the gas concentration of the stunning gas in the circulated stunning medium can be adjusted for each chamber portion 25, 27. The adjustment can be carried out continuously or—depending on the deviation on the basis of a target/actual comparison—stepwise. To that end, the gas concentration of the stunning gas in the circulated stunning medium can be detected after it has been suctioned out of the respective chamber portion 25, 27. If there is a deviation from a target value of the gas concentration—in the upper chamber portion, for example, from 20% and in the lower chamber portion, for example, from 40%—the gas concentration of the stunning gas in the circulated stunning medium is adjusted in that stunning gas and/or ambient air is supplied to the circulated stunning medium when it is returned into the respective chamber portion 25, 27. The stunning gas and/or the ambient air can be supplied externally-for example from separate reservoirs. Optionally, stunning medium having (excess) stunning gas could be suctioned out of the stunning chamber 12, preferably out of the second, lower chamber portion 27, and supplied, for example, to the first, upper chamber portion 25. Preferably, the circulation of the stunning medium and/or the adjustment of the gas concentration of the stunning gas in the circulated stunning medium are controlled separately for each chamber portion 25, 27.

Particularly preferably, the method is carried out using an apparatus 10 according to one or more of claims 1 to 19.

1-26. (canceled)

27. An apparatus, configured and adapted for stunning, in a stunning chamber, poultry animals for slaughter which are supplied in transport containers, comprising:
a stunning chamber;
a transport device for introducing the transport containers into the stunning chamber, transporting the transport containers through the stunning chamber and discharging the transport containers from the stunning chamber;
wherein;
the stunning chamber has at least one vertically oriented stunning shaft; and
the transport device comprises;
at least one lifting device, such that each transport container can be lowered into the stunning chamber from top to bottom on a first transport path, can be transported in a region of a bottom of the at least one stunning shaft transversely from the first transport path to a second transport path, and can be lifted from bottom to top on the second transport path; and
a device, arranged in the region of the bottom of the at least one stunning shaft, for introducing stunning gas into the stunning shaft so as to form inside the stunning chamber a stunning medium formed of ambient air and stunning gas; and
a ventilation system arranged inside the at least one stunning shaft of the stunning chamber, the ventilation system configured and adapted to circulate at least parts of the stunning medium at least in an upper region of the stunning chamber.

28. The apparatus according to claim 27, wherein the ventilation system comprises means for changing a gas concentration of the stunning gas in the circulated stunning medium.

29. The apparatus according to claim 27, wherein the ventilation system comprises at least a first pipe circuit, which is arranged at least in part inside the at least one stunning shaft, wherein the first pipe circuit is configured and adapted to suction stunning medium out of a first, upper chamber portion of the stunning chamber, which is located at an upper end of the stunning chamber, and to return the suctioned stunning medium into the first, upper chamber portion.

30. The apparatus according to claim 29, wherein the ventilation system comprises at least a second pipe circuit, which is arranged at least in part inside the at least one stunning shaft, wherein the second pipe circuit is configured and adapted to suction stunning medium out of a second, lower chamber portion of the stunning chamber, which is located below the first, upper chamber portion of the stunning chamber, and to return the suctioned stunning medium into the second, lower chamber portion.

31. The apparatus according to claim 29, wherein:
each of the at least first and at least second pipe circuits comprises at least pipes for conducting the stunning medium;
each pipe comprising, at a first free end of each of the pipes, a means for suctioning the stunning medium out of the respective chamber portion and, at the opposite, second free end of each of the pipes, means for returning the suctioned stunning medium into the respective chamber portion;
further comprising means for transporting the stunning medium through the pipes; and
measuring means for measuring the a gas concentration of the stunning medium suctioned out of the respective chamber portion.

32. The apparatus according to claim 29, wherein there are associated with each pipe circuit means for supplying stunning gas and/or ambient air into the pipes.

33. The apparatus according to claim 31, wherein each pipe consists of at least three portions, including at least one portion oriented vertically downwards, at least one portion oriented vertically upwards, and at least one horizontally oriented portion connecting the two vertically oriented portions.

34. The apparatus according to claim 31, wherein there is associated with each pipe at least one drive for suctioning the stunning medium into the pipe and returning the stunning medium from the pipe.

35. The apparatus according to claim 34, wherein the means for suctioning the stunning medium comprises at least one suction nozzle.

36. The apparatus according to claim 35, wherein the or each suction nozzle is oriented transversely and/or in parallel with respect to a vertically oriented portion of the corresponding pipe.

37. The apparatus according to claim 34, wherein the pipes each connect together the means for suctioning and the means for returning in each case by the shortest possible path.

38. The apparatus according to claim 34, wherein the measuring means for measuring the gas concentration of the stunning gas in the stunning medium suctioned out of the respective chamber portion is associated with the means for suctioning the stunning medium.

39. The apparatus according to claim 38, wherein the means for measuring the gas concentration comprises at least one sensor for detecting the gas concentration of the stunning gas in the suctioned stunning medium arranged inside each suction nozzle.

40. The apparatus according to claim 34, wherein the means for returning the stunning medium comprises at least one return nozzle.

41. The apparatus according to claim 40, wherein the or each return nozzle is oriented transversely and/or in parallel with respect to a vertically oriented portion of the corresponding pipe.

42. The apparatus according to claim 34, wherein a means for changing the gas concentration of the stunning gas is associated with the means for returning the stunning medium.

43. The apparatus according to claim 40, wherein means for an external supply of ambient air and/or stunning gas are associated with each return nozzle.

44. The apparatus according to claim 40, wherein there is arranged in the region of each return nozzle at least one supply pipe for supplying ambient air and/or stunning gas to the return nozzle.

45. The apparatus according to claim 27, wherein the ventilation system is connected to a control device for adjusting a gas concentration of the stunning gas in the stunning medium.

46. A method for stunning, in a stunning chamber, poultry animals for slaughter which are supplied to the stunning chamber in transport containers, comprising the steps:
introducing the transport containers with live and alert poultry animals for slaughter into the stunning chamber;
lowering the transport containers from top to bottom in a vertically oriented stunning shaft of the stunning chamber along a first transport path;
transporting the transport containers in a region of a bottom of the stunning shaft transversely from the first transport path to a second transport path, lifting the transport containers with stunned poultry animals for slaughter from bottom to top along the second transport path; and
discharging the transport containers;
wherein;
stunning gas is introduced into the stunning shaft in the region of the bottom of the stunning shaft so as to form inside the stunning chamber (12) a stunning medium formed of ambient air and stunning gas, such that the transport containers with the poultry animals for slaughter located therein pass along the first transport path firstly through a first, upper chamber portion having a first gas concentration of the stunning gas and then through a second, lower chamber portion having a second gas concentration of the stunning gas, wherein the second gas concentration in the lower chamber portion is higher than the first gas concentration;
the stunning medium being circulated at least in an upper region of the stunning chamber, at least in the first, upper chamber portion, and at least part of the stunning medium being suctioned out of the first, upper chamber portion and returned into the first, upper chamber portion.

47. The method according to claim 46, wherein the stunning medium is additionally and separately circulated in a lower region of the stunning chamber, in the second, lower chamber portion, and at least part of the stunning medium is suctioned out of the second, lower chamber portion and returned into the second, lower chamber portion.

48. The method according to claim 46, wherein the gas concentration of the stunning gas in the circulated stunning medium is adjusted for each chamber portion.

49. The method according to claim 46, wherein the gas concentration of the stunning gas in the circulated stunning medium is detected after suctioning out of the respective chamber portion.

50. The method according to claim 46, wherein the gas concentration of the stunning gas in the circulated stunning medium is adjusted if it deviates from a target value in that stunning gas and/or ambient air is supplied to the circulated stunning medium when it is returned into the respective chamber portion.

51. The method according to claim 48, wherein the circulation of the stunning medium and/or the adjustment of the gas concentration of the stunning gas in the circulated stunning medium is controlled separately for each chamber portion.

52. The method according to claim 46, wherein it is carried out using an apparatus comprising:
a stunning chamber;
a transport device for introducing the transport containers into the stunning chamber, transporting the transport containers through the stunning chamber and discharging the transport containers from the stunning chamber;
wherein;
the stunning chamber has at least one vertically oriented stunning shaft; and
the transport device comprises;
at least one lifting device, such that each transport container can be lowered into the stunning chamber from top to bottom on a first transport path, can be transported in a region of a bottom of the at least one stunning shaft transversely from the first transport path to a second transport path, and can be lifted from bottom to top on the second transport path; and
a device, arranged in the region of the bottom of the at least one stunning shaft, for introducing stunning gas into the stunning shaft so as to form inside the stunning chamber a stunning medium formed of ambient air and stunning gas; and
a ventilation system arranged inside the at least one stunning shaft of the stunning chamber, the ventilation system configured and adapted to circulate at least parts of the stunning medium at least in an upper region of the stunning chamber.
